(19) United States
(12) Patent Application Publication
(10) Pub. No.: US 2011/0206029 A1
(43) Pub. Date: Aug. 25, 2011

(54) COMMUNICATION APPARATUS, CONTROL METHOD, AND PROGRAM

(75) Inventor: Kenichi Fujii, Tokyo (JP)

(73) Assignee: CANON KABUSHIKI KAISHA, Tokyo (JP)

(21) Appl. No.: 13/125,952

(22) PCT Filed: Nov. 4, 2009
(86) PCT No.: PCT/JP2009/005839

§ 371 Date: Apr. 25, 2011

(30) Foreign Application Priority Data
Nov. 5, 2008 (JP) 2008-284512

(51) Int. Cl. H04W 84/02

(52) U.S. Cl. 370/338

(57) ABSTRACT

The convenience of users is improved for a case in which a network is structured by way of performance of a process of sharing communication parameters with other apparatuses.

A process of providing, so that an upper limit number of communication partners is M which is a plural number, communication parameters to a communication partner is performed in accordance with a predetermined operation performed by a user. When the predetermined operation is performed by the user again after the process has been performed, the communication parameters are provided to a communication partner so that an upper limit number of communication partners is one.

### TECHNICAL FIELD

The present invention relates to a communication apparatus that can share communication parameters with other apparatuses, a control method, and a program.

### BACKGROUND ART

In wireless communication typified by wireless local area networks (LANs) conforming to the Institute of Electrical and Electronics Engineers (IEEE) 802.11 standard series, there are many setting items that must be prior to use.

For example, as the setting items, there are communication parameters that are necessary to perform wireless communication, such as a service set identifier (SSID) which is a network identifier, an encryption method, an encryption key, an authentication method, and an authentication key. It is very complicated for a user to manually enter and set these communication parameters.

For this reason, various manufacturers have devised automatic setting methods for easily setting communication parameters in wireless apparatuses. In these automatic setting methods, using a procedure and messages that are determined in advance between apparatuses to be connected to each other, communication parameters are provided from one of the apparatuses to the other apparatus, and setting of the communication parameters is automatically performed.

In NPL, an example of automatic setting of communication parameters is disclosed.

In the automatic setting of communication parameters that is disclosed in NPL, a setting process is started by pressing a setting start button that is provided on an apparatus. While the setting process is being performed, automatic setting is performed between the apparatus and another apparatus in which the setting process is also started.

Furthermore, in PTL, an example of automatic setting of communication parameters among three or more apparatuses is disclosed. Furthermore, in PTL, a configuration is disclosed, in which one apparatus that is to provide communication parameters (hereinafter, referred to as a “providing apparatus”) is determined among apparatuses joining in a network, and in which the providing apparatus provides the communication parameters to the other apparatuses (hereinafter, referred to as “receiving apparatuses”).

### CITATION LIST

### Patent Literature

PTL 1: Japanese Patent Laid-Open No. 2006-352282

### Non Patent Literature

NPL 1: Wi-Fi CERTIFIED (unregistered trademark) for Wi-Fi Protected Setup: Easing the User Experience for Home and Small Office Wi-Fi (registered trademark) Networks, http://www.wi-fi.org/wp/wifi-protected-setup

### SUMMARY OF INVENTION

### Technical Problem

Here, a case is considered, in which automatic setting of communication parameters is performed among three or more apparatuses, and in which communication is performed on the same network.

In this case, when three apparatuses start automatic setting of communication parameters using button operations, first, the automatic setting of communication parameters is performed between two of the apparatuses. Then, the automatic setting of communication parameters is performed on the third apparatus. However, in order to continually perform the automatic setting of communication parameters on the third apparatus, another button operation needs to be performed on either one of the two apparatuses in which setting has been completed.

Furthermore, regarding apparatuses such as game machines, when a user plays a game utilizing communication with unspecified partners, when and how many partner apparatuses will request the user to perform setting (for joining in the game) are unknown. More particularly, when a user starts a game, a plurality of apparatuses simultaneously join in the game often. In such a case, if a button operation is necessary every time one apparatus is added, this causes a user to perform the button operation in a complicated manner.

The present invention aims to improve the convenience of users for a case in which a network is structured by way of performance of a process of sharing communication parameters with other apparatuses.

### Solution to Problem

A communication apparatus according to an aspect of the present invention includes the following elements: a first provision means for providing, so that the number of communication partners to which a communication parameter is to be provided is limited to M that is a plural number, the communication parameter to a communication partner in accordance with a predetermined operation performed by a user; and a second provision means for providing, so that an upper limit number of communication partners is one, the communication parameter to a communication partner in accordance with the predetermined operation performed by the user. When the predetermined operation is performed by the user again after a communication-parameter provision process performed by the first provision means has finished, the communication-parameter provision process is performed by the second provision means.

Furthermore, a communication apparatus according to another aspect of the present invention includes the following elements: a first provision means for providing a communication parameter to a plurality of communication partners during a period of time ending with a predetermined time limit in accordance with a predetermined operation performed by a user; and a second provision means for providing, so that an upper limit number of communication partners is one, the communication parameter to a communication partner in accordance with the predetermined operation performed by the user. When the predetermined operation is performed by the user again after a communication-parameter provision process performed by the first provision means has finished, the communication-parameter provision process is performed by the second provision means.

Moreover, a method for controlling a communication apparatus according to another aspect of the present invention includes controlling a communication apparatus to: perform a process of providing, so that an upper limit number of communication partners is M which is a plural number, a communication parameter to a communication partner in accordance with a predetermined operation performed by a user; and provide, when the predetermined operation is performed by the user again after the process has been performed, the communication parameter to a communication partner so that an upper limit number of communication partners is one.

### Advantageous Effects of Invention

According to the aspects of the present invention, the convenience of users can be improved for a case in which a network is structured by way of performance of a process of sharing communication parameters with other apparatuses.

### BRIEF DESCRIPTION OF DRAWINGS

FIG. 1 is a configuration diagram of a communication apparatus according to a first embodiment of the present invention.

FIG. 2 is a diagram of a software function block of the communication apparatus according to the first embodiment of the present invention.

FIG. 3 is a diagram of a network configuration in the first embodiment of the present invention.

FIG. 4 is a sequence diagram illustrating operations of apparatuses A and B according to the first embodiment of the present invention.

FIG. 5 is a diagram of a network configuration in the first embodiment of the present invention.

FIG. 6 is a sequence diagram illustrating operations of the apparatuses A and B and an apparatus C according to the first embodiment of the present invention.

FIG. 7 is a sequence diagram illustrating operations of the apparatuses A, B, and C according to the first embodiment of the present invention.

FIG. 8A is a first part of a flowchart of an operation of the communication apparatus according to the first embodiment of the present invention.

FIG. 8B is a second part of the flowchart of an operation of the communication apparatus according to the first embodiment of the present invention.

FIG. 8C is a third part of the flowchart of an operation of the communication apparatus according to the first embodiment of the present invention.

### DESCRIPTION OF EMBODIMENTS

### First Embodiment

Hereinafter, a communication apparatus according to a first embodiment will be described in detail with reference to the accompanying drawings. Hereinafter, examples in which a wireless LAN system conforming to IEEE 802.11 series is used are described. However, a communication form is not necessarily limited to a wireless LAN conforming to IEEE 802.11 series.

An exemplary hardware configuration in the first embodiment will be described.

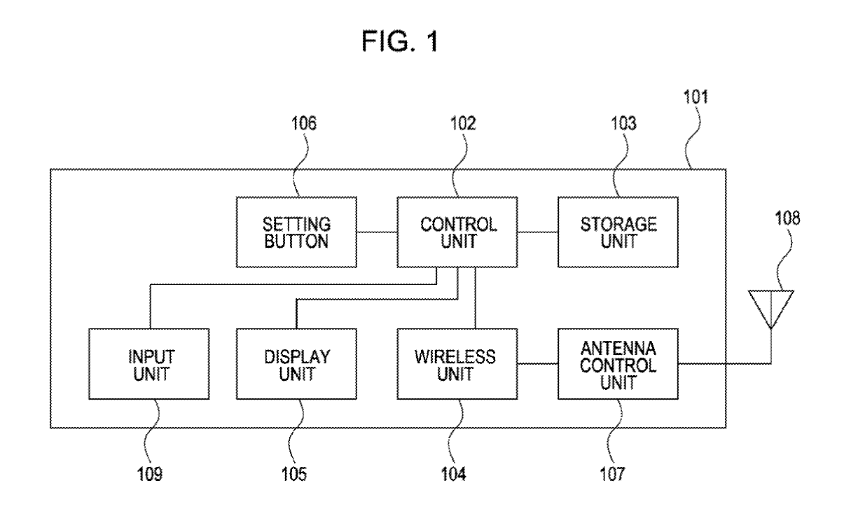

FIG. 1 is a block diagram showing an example of a configuration of each apparatus, which is described below, according to the first embodiment of the present invention. FIG. 1 illustrates the entirety of an apparatus 101. A control unit 102 controls the entire apparatus 101 by executing a control program that is stored in a storage unit 103. The control unit 102 also performs various types of control when the apparatus 101 performs a communication-parameter automatic setting process between the apparatus 101 and another apparatus. The storage unit 103 stores the control program that is executed by the control unit 102, and various types of information items such as communication parameters. Various types of operations described below are performed by executing, with the control unit 102, the control program that is stored in the storage unit 103.

A wireless unit 104 is used to perform wireless communication. A display unit 105 performs various types of displays. The display unit 105 has a function of capable of outputting visually recognizable information, such as a liquid crystal display (LCD) or a light-emitting diode (LED), or a function of capable of outputting a sound, such as a speaker.

A setting button 106 is used to supply a trigger for starting the communication-parameter automatic setting process. When the control unit 102 detects an operation of the setting button 106 that is performed by a user, the control unit 102 performs a process described below.

An antenna control unit 107 and an antenna 108 are provided. An input unit 109 is used by the user to input various types of inputs.

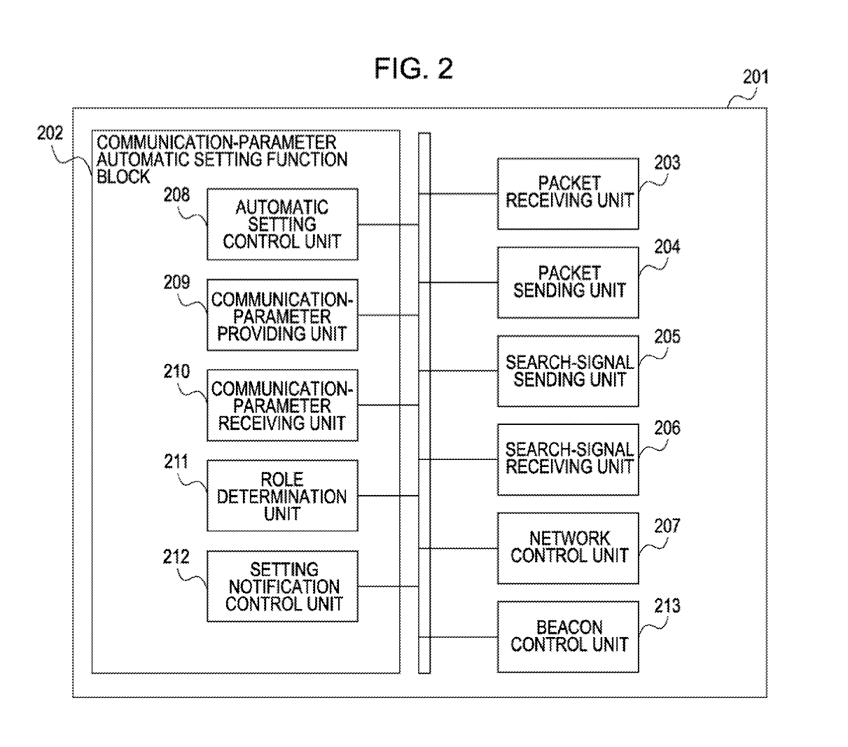

FIG. 2 is a diagram showing an example of a software function block that is used by each apparatus to perform an operation of setting communication parameters which is described below.

FIG. 2 illustrates the entirety of an apparatus 201. The apparatus 201 includes a communication-parameter automatic setting function block 202. In the first embodiment, the communication-parameter automatic setting process of automatically setting communication parameters that are necessary to perform wireless communication, such as an SSID which is a network identifier, an encryption method, an encryption key, an authentication method, and an authentication key, is performed.

A packet receiving unit 203 receives packets that are associated with various types of communication. Reception of a beacon (a report signal/broadcast signal) is performed by the packet receiving unit 203. A packet sending unit 204 sends packets that are associated with various types of communication. Sending of a beacon is performed by the packet sending unit 204. Note that an information item for structuring and maintaining a network, an information item for joining of an apparatus in a network, various type of information items concerning an apparatus that is a sender, and so forth are added to a beacon.

A search-signal sending unit 205 controls sending of an apparatus search signal, such as a probe request. A probe request may be called a network search signal for searching for a desired network. Sending of a probe request is performed by the search-signal sending unit 205. Furthermore, sending of a probe response, which is a response signal that is in response to a received probe request, is also performed by the search-signal sending unit 205.

A search-signal receiving unit 206 controls reception of an apparatus search signal, such as a probe request, from another apparatus. Reception of a probe request is performed by the search-signal receiving unit 206. Furthermore, reception of a probe response is also performed by the search-signal receiving unit 206. Note that various types of information items concerning an apparatus that is a sender are added to an apparatus search signal and a response signal that is in response to the apparatus search signal.

A network control unit 207 controls connection to a network. A process of connection to a wireless LAN ad-hoc network or the like is performed by the network control unit 207.

In the communication-parameter automatic setting function block 202, an automatic-setting control unit 208 controls various types of protocols in the communication-parameter automatic setting process.

A communication-parameter providing unit 209 provides communication parameters to a partner apparatus. A communication-parameter provision process included in the communication-parameter automatic setting process, which is described below, is performed by the communication-parameter providing unit 209 in accordance with control that is performed by the automatic setting control unit 208. Furthermore, the communication-parameter providing unit 209 performs a first provision process of providing communication parameters to a plurality of communication partners, and a second provision process of providing the communication parameters to one communication partner so that an upper limit number of communication partners is one. A communication-parameter receiving unit 210 receives communication parameters from a partner apparatus. A communication-parameter reception process included in the communication-parameter automatic setting process, which is described below, is performed by the communication-parameter receiving unit 210 in accordance with control that is performed by the automatic setting control unit 208.

In addition, the automatic-setting control unit 208 also determines whether a time that has elapsed after the communication-parameter automatic setting process started has exceeded a time limit of the communication-parameter automatic setting process. Furthermore, when it is determined that the time that has elapsed after the communication-parameter automatic setting process started has exceeded the time limit, the communication-parameter automatic setting process is discontinued in accordance with control that is performed by the automatic setting control unit 208.

Furthermore, whether or not the number of apparatuses in which a setting process is performed within the time limit of the communication-parameter automatic setting process after the communication-parameter automatic setting process started has exceeded a limit number of apparatuses is also determined by the automatic setting control unit 208. Additionally, when it is determined that the number of apparatuses in which the communication-parameter automatic setting process is performed within the time limit has exceeded the limit number of apparatuses, the communication-parameter automatic setting process is discontinued in accordance with control that is performed by the automatic setting control unit 208.

A role determination unit 211 determines a role (a providing apparatus or a receiving apparatus) in the communication-parameter automatic setting process. A role determination process, which is described below, is performed by the role determination unit 211.

A setting notification control unit 212 controls a process that is associated with notification of the start and end of the communication-parameter automatic setting process. A process of sending/receiving a start notification message, a start notification response message, and a completion notification message to/from a providing apparatus, which is described below, is performed by the setting notification control unit 212.

A beacon control unit 213 controls timing at which a beacon (a report signal) is sent.

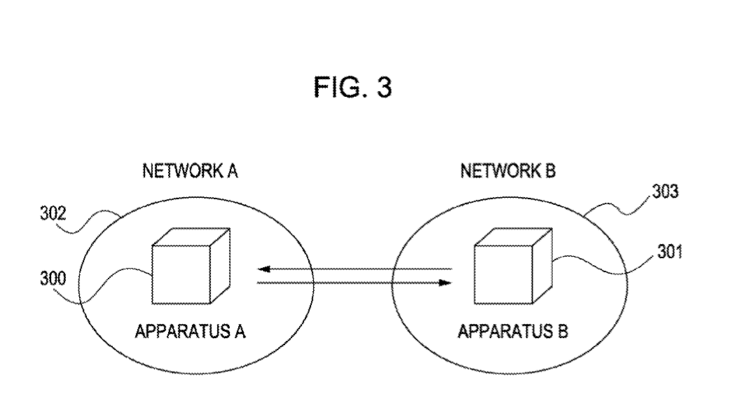

FIG. 3 is a diagram showing a communication apparatus A300 (hereinafter, referred to as an “apparatus A”) and a communication apparatus B301 (hereinafter, referred to as an “apparatus B”). These apparatuses have the configurations shown in FIGS. 1 and 2, which are described above.

Each of the apparatuses A and B operates as a providing apparatus that provides communication parameters or a receiving apparatus that receives communication parameters. Alternatively, the apparatuses A and B generate a network A302 (hereinafter, referred to as a “network A”) and a network B303 (hereinafter, referred to as a “network B”), respectively, in a state in which the roles of the apparatuses A and B have not been determined.

The apparatuses A and B find each other, and perform arbitration to determine which apparatus will serve as a providing apparatus. As a result, communication parameters are provided from an apparatus serving as a providing apparatus to an apparatus serving as a receiving apparatus.

Furthermore, the networks A and B are ad-hoc networks that are structured by the apparatuses A and B, respectively. An ad-hoc network is called an independent basic service set (MSS). Individual ad-hoc networks are distinguished from one another using basic service set identifiers (BSSIDs) that are network identifiers.

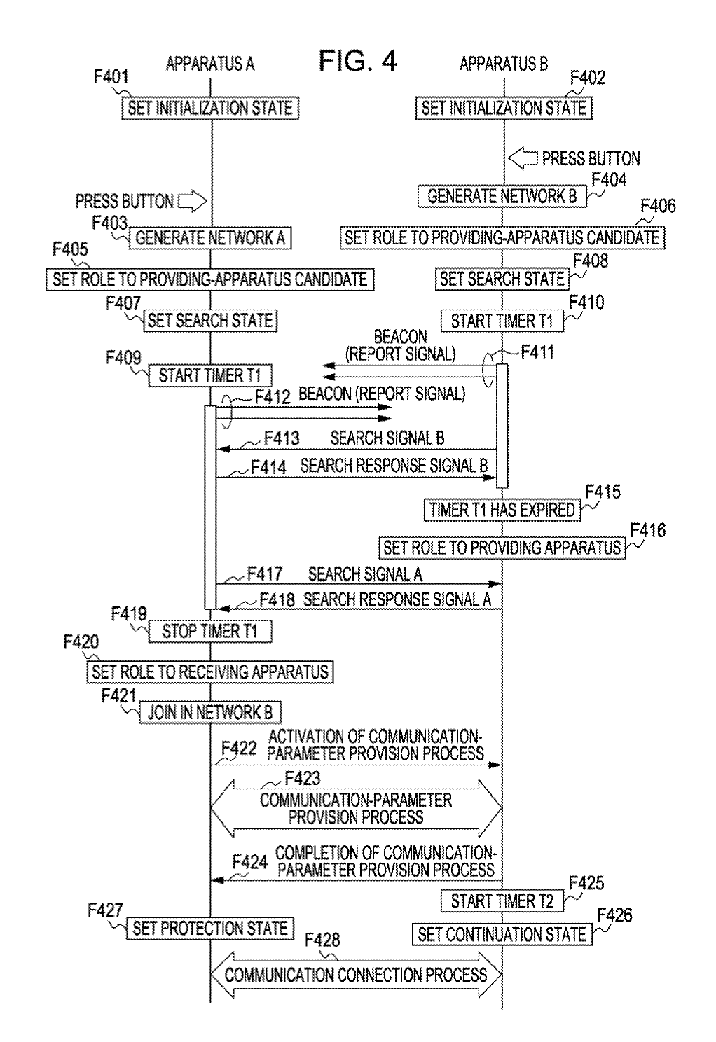

FIG. 4 is a diagram illustrating an example of a process sequence in a case in which users press the setting buttons 106 of the apparatuses A and B, and in which the communication-parameter automatic setting process is performed between the apparatuses A and B.

First, the apparatuses A and B are set to be in an initialization state (F401 and F402). Next, the setting buttons 106 are pressed. The apparatus A generates the unique network A (F403), and the apparatus B also generates the unique network B (F404). When the setting buttons 106 are pressed, the apparatuses A and B start the communication-parameter automatic setting process. In the communication-parameter automatic setting process, roles are determined using the role determination process, and the communication-parameter provision process of providing communication parameters from a providing apparatus to a receiving apparatus is performed. The communication-parameter provision process can be realized using a communication protocol process that is defined in a communication-parameter setting process whish is an industry standard as described in NPL. Furthermore, the communication-parameter provision process can also be realized using a unique communication protocol process if the apparatuses support the communication protocol process.

Next, each of the apparatuses A and B sets an operation role (hereinafter, referred to as a “role”) thereof to a providing-apparatus candidate indicating that whether the apparatus will serve as a providing apparatus or a receiving apparatus has not been determined (F405 and F406). Furthermore, the apparatuses A and B set the states the states thereof to a search state (F407 and F408), and start timers T1 (F409 and F410). Each of the timers T1 indicates an arbitration time for an operation role, and is used to set the operation role of an apparatus whose timer T1 has first expired to a providing apparatus. Accordingly, when no providing apparatus has been detected before the timer T1 expires, an apparatus whose timer T1 has first expired will serve as a providing apparatus. Furthermore, when an apparatus has detected a providing apparatus before the timer T1 of the apparatus expires, the apparatus sets the role thereof to a receiving apparatus.

Each of the apparatuses A and B sends, after a corresponding one of the timers T1 has started, a beacon (a report signal) (F411 and F412). The beacon includes an information element indicating that the apparatus has a function of the communication-parameter automatic setting process. Note that the information element may be an information element indicating that the communication-parameter automatic setting process is being performed. Furthermore, the beacon may include an information element indicating a providing-apparatus candidate that is the current role.

In the beacon, a BSSID is included. The BSSID of the network A is different from the BSSID of the network B. Accordingly, an apparatus that has received the beacon can recognize a network to which an apparatus that sent the beacon belongs.

Then, the apparatus B sends a search signal B (F413). In the search signal B, as in the beacon, an information element indicating that the apparatus has the function of the communication-parameter automatic setting process or indicating that the communication-parameter automatic setting process is being performed, and an information element indicating a providing-apparatus candidate that is the current role are included.

When the apparatus A receives the search signal B that was sent from the apparatus B, the apparatus A sends a search response signal B to the apparatus B (F414). Also in the search response signal B, as in the beacon and as in the search signal A, an information element indicating that the apparatus has the function of the communication-parameter automatic setting process or indicating that the communication-parameter automatic setting process is being performed, and an information element indicating a providing-apparatus candidate that is the current role are included.

It is supposed that the timer T1 of the apparatus B, which indicates the arbitration time for an operation role, has expired earlier than the timer T1 of the apparatus A (F415). When the timer T1 of the apparatus B has expired, the apparatus B sets the operation role thereof to a providing apparatus (F416).

Next, the apparatus A sends a search signal A (F417). Also in the search signal A that is sent from the apparatus A, an information element indicating that the apparatus has the function of the communication-parameter automatic setting process or indicating that the communication-parameter automatic setting process is being performed, and an information element indicating a providing-apparatus candidate that is the current role are included.

When the apparatus B receives the search signal A that was sent from the apparatus A, the apparatus B sends a search response signal A to the apparatus A (F418). Also in the search response signal A, as in the beacon and as in the search signal A, an information element indicating that the apparatus has the function of the communication-parameter automatic setting process or indicating that the communication-parameter automatic setting process is being performed is included. However, for the current role, an information element indicating a providing apparatus is included. Here, in addition to the information element indicating a providing apparatus as a role, an information element indicating that the apparatus is in a state in which the apparatus can provide communication parameters may be added.

When the apparatus A receives the search response signal A that was sent from the apparatus B, the apparatus A verifies that the role of the apparatus B is a providing apparatus, and that the apparatus B is in a state in which the apparatus can provide communication parameters. Then, the apparatus A stops the timer T1 for arbitration (F419), sets the role thereof to a receiving apparatus (F420), and joins in the network B that the apparatus B generated (F421). In other words, the receiving apparatus joins in the network of the providing apparatus. Accordingly, the apparatuses A and B join together in the same network B, and communication messages that should be exchanged in the communication-parameter automatic setting process can be mutually sent/received between the apparatuses A and B. Up to this point, the process sequence from the beginning to the role determination process is completed. Furthermore, for joining of the apparatus A in the network B in F421, the apparatus A has not formally received communication parameters from the apparatus B. Accordingly, in this state, data communication in a formal manner (encrypted communication or the like) cannot be performed in the network B. Only communication using a special control packet can be performed. The communication-parameter provision process is performed utilizing this special packet.

Here, when arbitration for a role that is a providing apparatus which provides communication parameters or a receiving apparatus which receives communication parameters is performed between the apparatuses A and B, a search signal and a search response signal are used. However, search for a partner apparatus and arbitration for determination of a role may be performed using a passive scan in which a beacon is mutually sent/received between apparatuses without sending/receiving a search signal and a search response signal.

The apparatus A that joins in the network B sends, to the apparatus B, a message for an instruction for activating the communication-parameter provision process (F422). The communication-parameter provision process is performed between the apparatus A serving as a receiving apparatus and the apparatus B serving as a providing apparatus (F423). As a result, communication parameters are sent (provided) from the apparatus B to the apparatus A. When the communication-parameter provision process normally finishes, the apparatus B sends, to the apparatus A, a message concerning a completion of the communication-parameter provision process (F424). Accordingly, the communication-parameter provision process is completed. Note that the communication parameters that the apparatus B provides may be communication parameters for the network B or communication parameters other than the communication parameters for the network B.

After the apparatus B sent the communication parameters to the apparatus A, the apparatus B serving as a providing apparatus starts a timer T2 indicating a first predetermined time limit for continuously accepting a new apparatus (F425). The apparatus B sets the state thereof to a continuation state (F426). On the other hand, the apparatus A sets the state thereof to a protection state, thereby entering a state in which the communication-parameter automatic setting process is not activated (F427). In other words, the providing apparatus continues the communication-parameter automatic setting process, and holds a state in which the apparatus serving as a providing apparatus can provide the communication parameters to further another apparatus. When the receiving apparatus receives the communication parameters from the providing apparatus, the receiving apparatus finishes the communication-parameter automatic setting process.

Then, the apparatuses A and B perform a communication connection process using the communication parameters that are shared as a result of the communication-parameter automatic setting process (F428). Communication at this stage is performed in a state in which the communication parameters are shared. Accordingly, the state is different from the state in F421, and encrypted communication that is defined using the shared communication parameters or the like can also be performed.

Note that, when the communication-parameter provision process finishes, the communication connection process immediately starts, whereby the apparatuses A and B can communicate with each other without forcing a user to perform another operation. In this case, a connection request signal clearly indicating that an apparatus has started the communication connection process may be sent. By utilizing the connection request signal that is sent from an apparatus which joins in the network in which the provided communication parameters are necessary, the apparatus B can recognize that the apparatus has requested connection to the network, and can also easily grasp the number of apparatuses that join in the network. Furthermore, before the communication connection process starts, the apparatus B is instructed, by a user operation, to check the start of connection, whereby the apparatus B may start the communication connection process. Furthermore, the apparatus B starts, using a detection of another apparatus on the network as a trigger, the communication connection process, whereby an unnecessary connection process can be prevented.

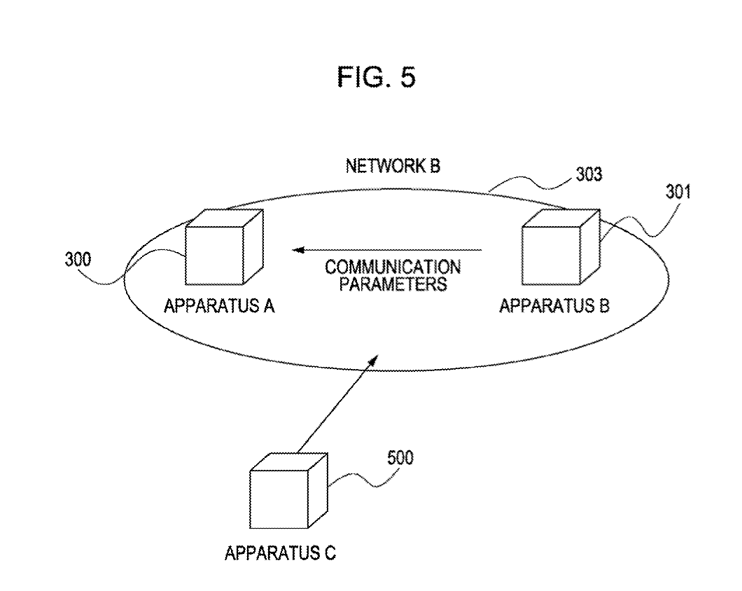

FIG. 5 is a diagram showing the first communication apparatus A300 (the apparatus A), the second communication apparatus B301 (the apparatus B), a third communication apparatus C500 (hereinafter, referred to as an “apparatus C”), and a network B303. The apparatuses A, B and C have the configurations shown in FIGS. 1 and 2, which are described above.

The apparatuses A and B join in the ad-hoc network B using the process illustrated in FIG. 4. A process for joining of the apparatus C in the ad-hoc network B will be described. Note that the apparatus B provided the communication parameters for the network B to the apparatus A, and the apparatuses A and B are in a state in which the apparatuses join in the network B. Hereinafter, the following two cases will be described: a case in which only the setting button 106 of the apparatus C is operated, and in which the apparatus C joins in the network B: and a case in which the setting buttons 106 of the apparatuses A and C are operated, and in which the apparatus C joins in the network B.

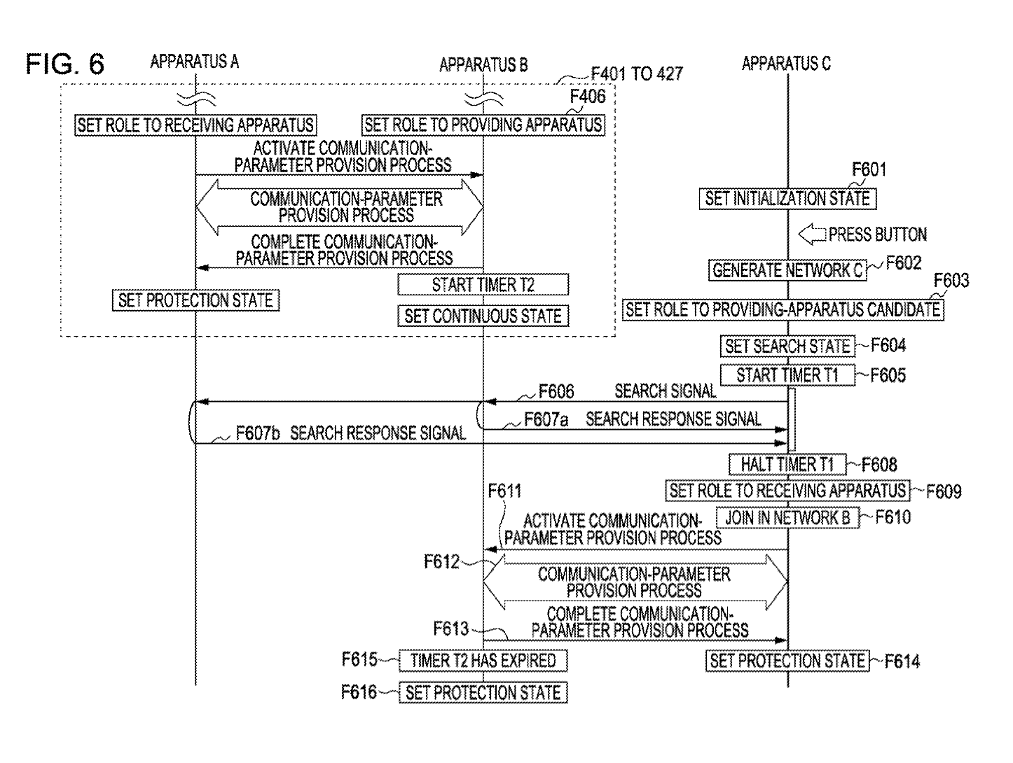

FIG. 6 is a sequence diagram for explaining an operation of each of the apparatuses.

FIG. 6 illustrates a sequence in a case in which only the setting button 106 of the apparatus C is operated.

A process that is similar to the process which is described above with reference to FIG. 4 is performed. More specifically, the communication parameters for the network B are provided from the apparatus B serving as a providing apparatus to the apparatus A serving as a receiving apparatus. The apparatus A sets the state thereof to the protection state. The apparatus B starts the timer T2, and sets the state thereof to the continuation state.

In the apparatus C, the state thereof is set to the initialization state (F601). When a user operates the setting button 106 of the apparatus C, the apparatus C starts the communication-parameter automatic setting process. When the apparatus C has started the communication-parameter automatic setting process, the apparatus C structures a network C (F602). Furthermore, the apparatus C sets the operation role thereof to a providing-apparatus candidate indicating that whether the apparatus will serve as a providing apparatus or a receiving apparatus has not been determined (F603). Next, the apparatus C sets the state thereof to the search state (F604), and starts a timer T1 indicating the arbitration time for an operation role (F605).

After the apparatus C has started the timer T1, the apparatus C sends a search signal (F606). The search signal includes an information element indicating that the apparatus has the function of the communication-parameter automatic setting process or indicating that the communication-parameter automatic setting process is being performed, and an information element indicating a providing-apparatus candidate that is the current role.

When the apparatuses A and B receive the search signal that was sent from the apparatus C, the apparatuses A and B send back search response signals (F607a and F607b).

In a case in which the apparatus A that has already been in the protection state sends back a search response signal, the apparatus A sends back a search response signal not indicating that the apparatus A activates the communication-parameter automatic setting process (F607b). Alternatively, the apparatus A may send back a search response signal indicating that the apparatus A does not activate the communication-parameter automatic setting process.

Additionally, in a case in which the apparatus B in the continuation state sends back a search response signal, the apparatus B stores, in a search response signal, an information element indicating that the apparatus B serves as a providing apparatus, and sends back the search response signal (F607a). Here, in addition to the information element indicating a providing apparatus as a role, an information element indicating that the apparatus is in a state in which the apparatus can provide communication parameters may be added.

The apparatus C receives the search response signal from the apparatus B (F607a), thereby detecting existence of a providing apparatus. The apparatus C sets the role thereof to a receiving apparatus (F609). Furthermore, the apparatus C stops the timer T1 (F608).

Next, the apparatus C joins in the network B in which the providing apparatus exists (F610), and sends, to the apparatus B, a message for an instruction for activating the communication-parameter provision process (F611).

The communication-parameter provision process is performed between the apparatus C serving as a receiving apparatus and the apparatus B serving as a providing apparatus (F612). As a result, the communication parameters are sent (provided) from the apparatus B to the apparatus C. Here, because the apparatus B provided the communication parameters for the network B to the apparatus A, the apparatus B also provides the communication parameters for the network B to the apparatus C. In other words, the apparatus C receives, from the apparatus B serving as a providing apparatus, the communication parameters that are necessary for communication in the network B (F613).

After the apparatus B has provided the communication parameters to the apparatus C, the apparatus B sends a completion notification message (F613).

When the apparatus C receives the completion notification message, the apparatus C sets the state thereof to the protection state, thereby entering a state in which the apparatus does not activate the communication-parameter automatic setting process (F614).

On the other hand, the apparatus B waits until the timer T2, which indicates the time limit for continuously performing the communication-parameter automatic setting process between the apparatus and another apparatus, expires. When the setting button 106 of another apparatus has been pressed before the timer T2 of the apparatus B expires, the apparatus B provides the communication parameters for the network B to the apparatus as in the case of the apparatus C. When the timer T2 expires (F615), the apparatus B sets the state thereof from the continuation state to the protection state in which the apparatus does not activate the communication-parameter automatic setting process (F616).

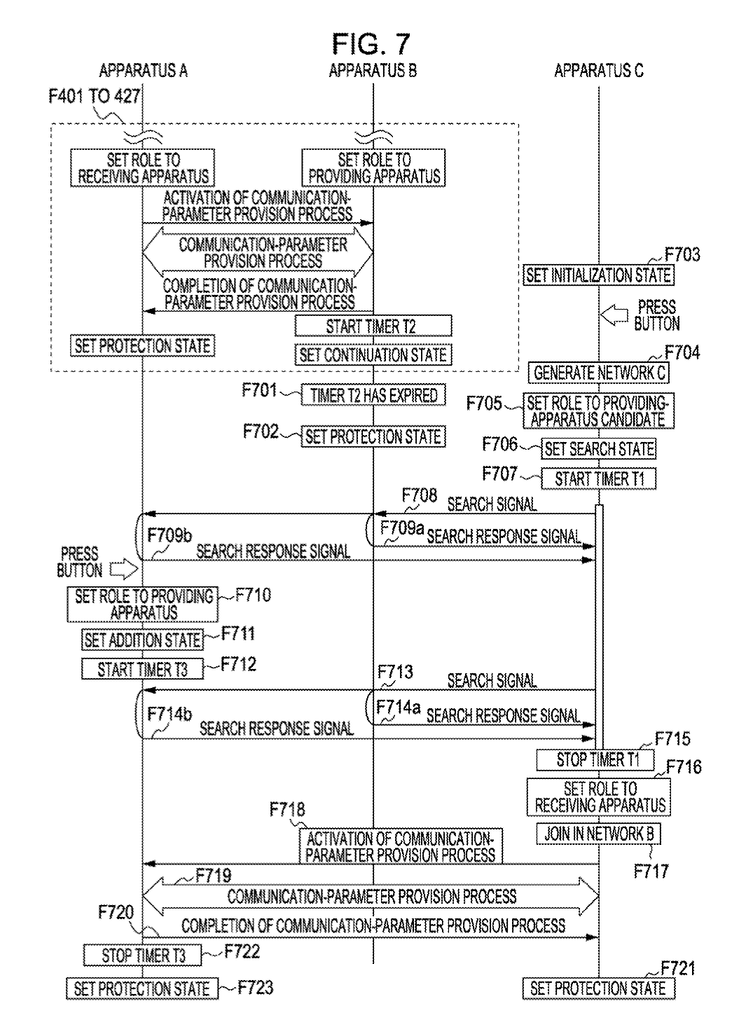

As described above, without an operation of the setting button 106 being performed by the user who uses the apparatus B, the communication-parameter automatic setting process between the apparatus B and another apparatus is continuously enabled for the fixed time. Thus, this can allow the apparatus C to automatically join in the network B. Furthermore, regarding communication parameters that are provided when the apparatus B is in the continuation state, communication parameters that are the same as the communication parameters that have already been provided to another apparatus are provided. Thus, this can allow a plurality of apparatuses to join in the same network. FIG. 7 is a sequence diagram for explaining an operation of each of the apparatuses in a case in which the setting buttons of the apparatuses A and C are operated, and in which the apparatus C joins in the network B.

A process that is similar to the process which is described above with reference to FIG. 4 is performed. More specifically, the communication parameters for the network B are provided from the apparatus B serving as a providing apparatus to the apparatus A serving as a receiving apparatus. The apparatus A sets the state thereof to the protection state. The apparatus B starts the timer T2, and sets the state thereof to the continuation state.

After that, the timer T2, which indicates the time limit for continuation of the communication-parameter automatic setting process, of the apparatus B expires (F701). The apparatus B sets the state thereof to the protection state indicating that the communication-parameter automatic setting process is not activated (F702).

In this state, when the setting button 106 of the apparatus C in the initialization state (F703) is operated by the user, the apparatus C starts the communication-parameter automatic setting process. When the apparatus C starts the communication-parameter automatic setting process, the apparatus C structures a network C (F704). The apparatus C sets the role thereof to a providing-apparatus candidate (F705). Then, the apparatus C sets the state thereof to the search state (F706), and starts the tinier T1 of the apparatus C (F707). In this state, even when the apparatus C sends a search signal (F708), because the apparatuses A and B are in the protection state, the apparatuses A and B send back search response signals not indicating that the apparatuses A and B activate the communication-parameter automatic setting process (F709a and F709b). Alternatively, the apparatuses A and B send back search response signals indicating that the apparatuses A and B do not activate the communication-parameter automatic setting process (F709a and F709b).

On the other hand, the setting button 106 of the apparatus A is operated. Here, because the apparatus A has already completed the communication-parameter automatic setting process between the apparatus A and B, the apparatus A sets the role thereof to a providing apparatus simultaneously with the operation of the setting button 106 performed by a user (F710).

Next, the apparatus A sets the state thereof to an addition state in which the apparatus A can perform the communication-parameter automatic setting process between the apparatus A and one different apparatus (F711). The apparatus A starts a timer T3 indicating a second predetermined time limit (F712). When the apparatus A has not received any request for providing the communication parameters from another apparatus before the timer T3 expires, the apparatus A sets the state thereof to the protection state, and finishes the communication-parameter automatic setting process. When the apparatus A has received a request for providing the communication parameters from another apparatus before the tinier T3 expires, the apparatus A provides the communication parameters that were provided from the apparatus B (the communication parameters for the network in which the apparatus A is joining).

Here, the apparatus C sends the search signal again because the timer T1 has not expired (F713). In the search signal, an information element indicating that the apparatus has the function of the communication-parameter automatic setting process or indicating that the communication-parameter automatic setting process is being performed, and an information element indicating a providing-apparatus candidate that is the current role are included.

For the search signal that was sent from the apparatus C, the apparatus A or B sends back a search response signal (F714a or F714b).

In a case in which the apparatus B sends hack a search response signal, the apparatus B sends back a search response signal not indicating that the apparatus B does not activate the communication-parameter automatic setting process (F714a). Furthermore, in a case in which the apparatus A sends back a search response signal, the apparatus A stores, in a search response signal, an information element indicating that the apparatus A serves as a providing apparatus, and sends back the search response signal (F714b).

The apparatus C receives the search response signal from the apparatus A, thereby detecting existence of a providing apparatus. The apparatus C sets the role thereof to a receiving apparatus (F716). Furthermore, the apparatus C stops the timer T1 (F714).

The apparatus C that set the role thereof to a receiving apparatus joins in the network B in which the providing apparatus exists (F717), and activates the communication-parameter reception process. The apparatus C that activated the communication-parameter reception process sends, to the apparatus A, a message for an instruction for activating the communication-parameter provision process (F718). The apparatus C receives, from the apparatus A serving as a providing apparatus, the communication parameters that are necessary for communication in the network B (F719). Furthermore, the apparatus A provides, to the apparatus C, the communication parameters, which were provided from the apparatus B, for the network B in which the apparatus A joins (F719).

After the apparatus A has provided the communication parameters to the apparatus C, the apparatus A sends a completion notification message (F720).

When the apparatus C receives the completion notification message, the apparatus C sets the state thereof to the protection state, thereby entering a state in which the communication-parameter automatic setting process is not activated (F721).

On the other hand, after the apparatus A have provided the communication parameters to the apparatus C, the apparatus A stops the timer T3 (F722). The apparatus A sets the state thereof from the addition state to the protection state in which the communication-parameter automatic setting process is not activated (F723).

As described above, the operation of the setting button 106 of the apparatus A serving as a receiving apparatus that receives communication parameters can also allow the apparatus C to join in the network B.

Furthermore, referring to FIG. 7, a case is described, in which the setting button 106 of the apparatus C is operated after the timer T2 of the apparatus B has expired. However, in a case in which the setting button 106 of the apparatus A is operated while the timer T2 of the apparatus B is operating, i.e., while the apparatus B is being in the continuation state, the apparatus C can perform the communication-parameter automatic setting process between the apparatus C and both the apparatuses A and B.

Additionally, regarding the state of the apparatus B, only a case in which the state of the apparatus B changes from the continuation state in which the timer T2 is operating to the protection state that is set after the timer T2 has expired is described. However, the apparatus B that has been in the protection state can also be set, using the operation of the setting button 106, to be in the addition state, and can provide the communication parameters as in the above-described case of the apparatus A.

Moreover, when the apparatus B is in the continuation state and the setting button 106 of the apparatus B is pressed, the time indicated by the timer T2 may be extended. Alternatively, the apparatus B may immediately enter the addition state.

In addition, in the above description, a providing apparatus starts the timer T2 after the providing apparatus provides communication parameters to a receiving apparatus. However, an apparatus may start the timer T2 thereof after it is determined that the role of the apparatus is a providing apparatus. In this manner, during a predetermined period of time from when it is determined that the role of an apparatus is a providing apparatus to when the timer T2 of the apparatus expires, the apparatus can provide communication parameters to a plurality of receiving apparatuses. Furthermore, the number of receiving apparatuses to which a providing apparatus can provide communication parameters may be limited. In this manner, even during a period of time until the timer T2 of a providing apparatus expires, the providing apparatus can provide communication parameters only to a predetermined number, which is determined in advance, of receiving apparatuses.

Hereinafter, an apparatus starts the timer T2 thereof after it is determined that the role of the apparatus is a providing apparatus, and further, the number of apparatuses to which the providing apparatus can provide communication parameters is also limited in advance.

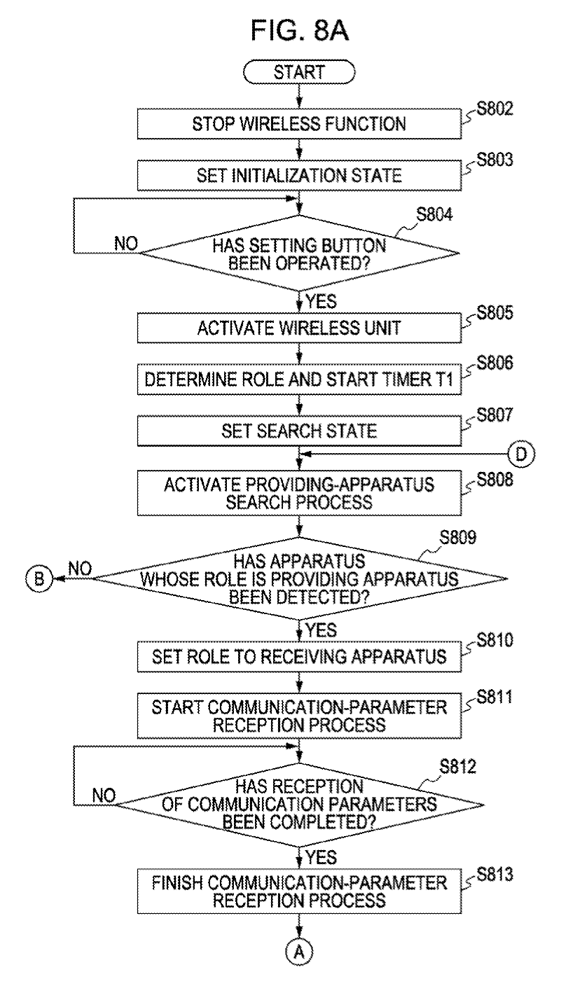

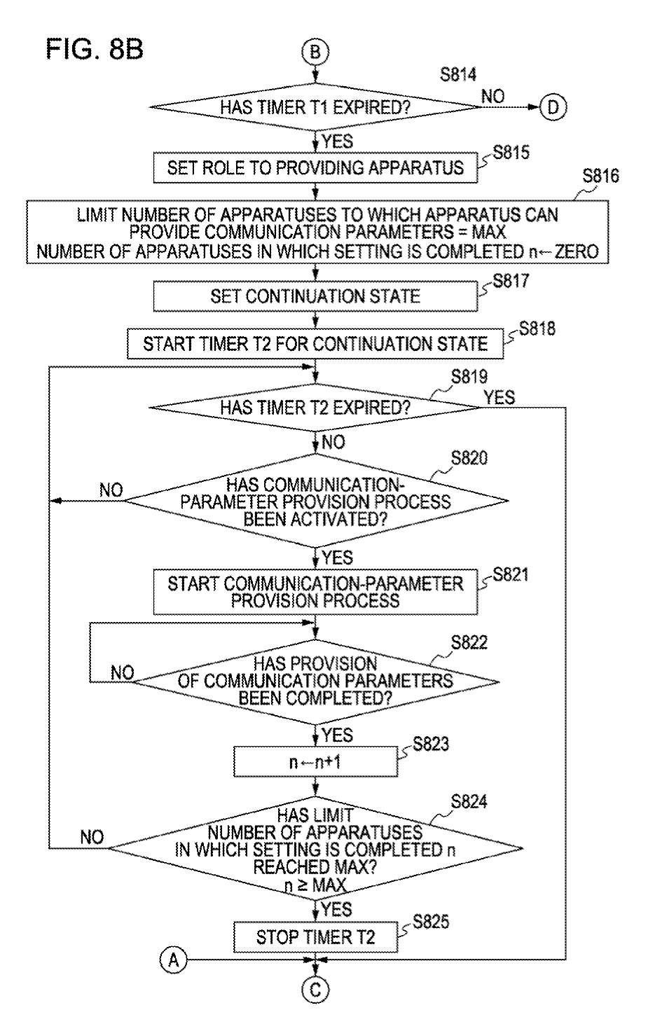

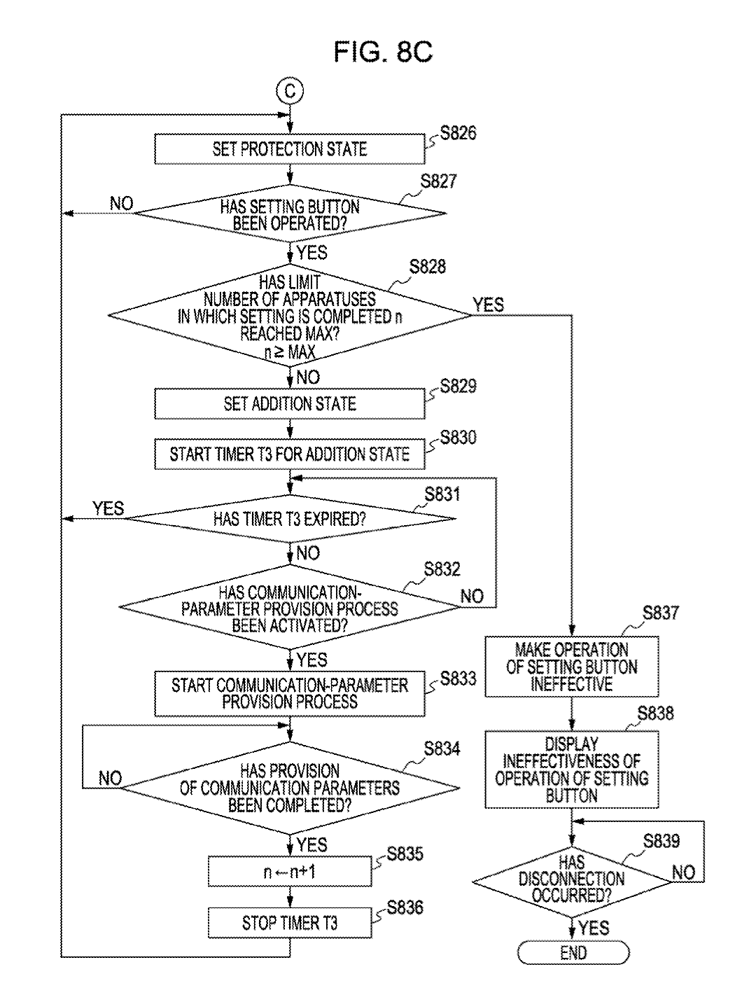

FIGS. 8A to 8B are parts of a flowchart showing an example of an operation flow in a case in which the setting button 106 of the apparatus A or B is operated, and in which the communication-parameter automatic setting process is performed. This flowchart can be applied to any of the apparatuses A and B.

First, in each of the apparatuses, a wireless function is stopped (S802). The state of the apparatus is set to the initialization state (S803).

In order to activate the communication-parameter automatic setting process for sharing communication parameters with a communication partner, the setting button 106 is operated by a user. When the control unit 102 determines that the setting button 106 has been operated (S804), the control unit 102 activates the wireless unit 104 (S805). When the wireless unit 104 is activated, the apparatus structures a network, and starts sending a beacon. In addition, the apparatus starts the timer T1 for determination of a role (S806). Furthermore, at this state, the apparatus sets the role thereof to a providing-apparatus candidate. The apparatus sets the state thereof to the search state (S807), and activates a providing-apparatus search process (S808).

Herein, the providing-apparatus search process is performed by sending/receiving a beacon (a report signal), by sending/receiving a search signal (a probe request), and by sending/receiving a search response signal (a probe response). In each of the signals, an information element indicating that the apparatus has the function of the communication-parameter automatic setting process or indicating that the communication-parameter automatic setting process is being performed, an information element indicating a role, and an information element indicating whether or not a provision function is being activated are included on an as needed basis.

Next, the apparatus determines whether or not the apparatus has detected an apparatus whose role is a providing apparatus (S809). When the apparatus has detected a providing apparatus, the apparatus sets the role thereof to a receiving apparatus (S810), and starts the communication-parameter reception process (S811). The apparatus that activates the communication-parameter reception process sends, to the providing apparatus, a message for an instruction for activating the communication-parameter provision process, and receives communication parameters from the providing apparatus. When reception of communication parameters is completed (S812), the apparatus finishes the communication-parameter reception process (S813). The apparatus proceeds to S826. In contrast, when the apparatus has not detected a providing apparatus (S809), the apparatus repeats the providing-apparatus search process while the timer T1 is operating (S814). When the timer T1 has expired without detection of a providing apparatus, the apparatus sets the role thereof to a providing apparatus (S815). Next, the apparatus sets a limit number of apparatuses to which the apparatus can provide communication parameters to M that is a plural number (sets an upper limit number of apparatuses to which the apparatus can provide communication parameters to MAX), and sets the current number of apparatuses in which setting is completed n to zero (S816).

Then, the apparatus sets the state thereof to the continuation state, in which the apparatus can continuously perform the communication-parameter automatic setting process between the apparatus and another apparatus (S817). The apparatus starts the timer T2 indicating the time limit of the continuation state (S818). When the apparatus has been instructed by a receiving apparatus to activate the communication-parameter provision process while the apparatus is being in the continuation state before the timer T2 expires, the apparatus activates the communication-parameter provision process (S820). Then, the apparatus starts the communication-parameter provision process (S821). When provision of communication parameters is completed (S822), the apparatus increments the number of apparatuses in which setting is completed n by one (S823). The apparatus determines whether or not the number of apparatuses in which setting is completed n has reached the limit number of apparatuses to which the apparatus can provide communication parameters MAX (S824). When the number of apparatuses in which setting is completed n has not reached the limit number of apparatuses to which the apparatus can provide communication parameters MAX, the apparatus waits until the apparatus is instructed to activate the communication-parameter provision process (S820), while the timer T2 is operating (S819).

When the timer T2 has expired, the apparatus finishes functioning as a providing apparatus, and finishes the communication-parameter automatic setting process. The apparatus proceeds to S826. Furthermore, even when the timer T2 has not expired, in a case in which the number of apparatuses in which setting is completed n has reached the limit number of apparatuses to which the apparatus can provide communication parameters MAX, the apparatus stops the timer T2 (S825). The apparatus finishes functioning as a providing apparatus, and finishes the communication-parameter automatic setting process. The apparatus proceeds to S826.

In a case in which the apparatus finishes the communication-parameter reception process (S813), or in a case in which the apparatus finishes functioning as a providing apparatus (S819 or S825), the apparatus sets the state thereof to the protection state in which the communication-parameter automatic setting process is not activated (S826). Then, the apparatus checks whether or not the setting button 106 has been operated again (S827). When the apparatus detects that the setting button 106 has been operated (S827), the apparatus checks whether or not the number of apparatuses in which setting is completed n has already reached the limit number of apparatuses to which the apparatus can provide communication parameters MAX (S828). When the number of apparatuses in which setting is completed n has reached the limit number of apparatuses to which the apparatus can provide communication parameters MAX, the apparatus makes the operation of the setting button 106 ineffective or ignores the operation of the setting button 106 (S837). Then, the apparatus notifies the user of ineffectiveness of the operation of the setting button 106 using a pattern or color display, a virtually recognizable information output, or a sound output (S838). The pattern or color display can be realized by causing an LED to blink or by illuminating an LED. The virtually recognizable information output can be realized, for example, by displaying a message on an LCD. The sound output can be realized, for example, using a speaker. In this case, the apparatus may notify the user of the fact that the number of apparatuses to which the apparatus has provided communication parameters has reached the limit number of apparatuses to which the apparatus can provide communication parameters together with the ineffectiveness of the operation of the setting button 106. Here, determination in S828 may be performed only by the apparatus that has functioned as a providing apparatus. Alternatively, when the setting button 106 of an apparatus that has functioned as a receiving apparatus is operated, the apparatus that has functioned as a receiving apparatus may inquires, of the apparatus that has functioned as a providing apparatus, the number of apparatuses in which setting is completed and the limit number of apparatuses to which the providing apparatus can provide communication parameters. The apparatus that has functioned as a receiving apparatus may perform determination in S828 on the basis of a response to the inquiry. Then, the apparatus continues communication until disconnection occurs (S839). In contrast, in a case in which an operation of the setting button 106 is detected (S827), and in which the number of apparatuses in which setting is completed n has not reached the limit number of apparatuses to which the apparatus can provide communication parameters MAX (S828), the apparatus sets the state thereof to the addition state in which the apparatus can perform the communication-parameter provision process (S829). Note that, in a case in which the apparatus does not perform determination in S828, when an operation of the setting button 106 is detected (S827), the apparatus sets the state thereof to the addition state in which the apparatus can perform the communication-parameter provision process (S829).

The apparatus starts the timer T3 for holding the addition state (S830). As described above, the addition state is a state in which the apparatus can provide the communication parameters to one different apparatus. Then, when the apparatus is instructed by a receiving apparatus to activate the communication-parameter provision process (S832), the apparatus starts the communication-parameter provision process (S833). After that, provision of the communication parameters is completed (S834), the apparatus increments the number of apparatuses in which setting is completed n by one (S835). The apparatus stops the timer T3, and the apparatus returns to S826. Furthermore, in a case in which the apparatus has not been instructed to activate the communication-parameter provision process (S832), and in which the timer T3 has expired (S831), the apparatus returns to S826.

Then, the apparatus sets the role thereof to the protection state again (S826), and waits until the user operates the setting button 106 (S827).

Note that, in the above description, when the setting button 106 is operated again after the apparatus has set the state thereof to the protection state, the apparatus sets the state thereof to the addition state, and provides the communication parameters to an additional apparatus. The apparatus may be designed so that the apparatus does not enter the addition state even when the setting button 106 is operated after the apparatus set the state thereof to the protection state and a predetermined time has elapsed. With the above-designed apparatus, the following configuration can be realized: during a predetermined period of time after the apparatus provides or receives communication parameters, joining of another apparatus in the network using the communication-parameter automatic setting process is allowed; and, however, after the predetermined period of time elapses, joining of another apparatus in the network using the communication-parameter automatic setting process is not allowed.

Furthermore, because joining of a plurality of communication apparatuses can be accepted using only one button operation, an operation of accepting joining in the same network is simplified. Additionally, even when the role of an apparatus in the communication-parameter automatic setting process that is performed using a first button operation is a providing apparatus or a receiving apparatus, joining of one new communication apparatus is accepted using each of the subsequent button operations. Thus, all communication apparatuses can allow the second and subsequent button operations to be performed regardless of the roles of the communication apparatuses, whereby convenience for automatic setting of communication parameters can be improved.

Moreover, even in a case in which a first communication-parameter automatic setting process finishes, if the setting button is operated again, an apparatus that is to join in the network can be added. Additionally, because the number of additional apparatuses is one, joining of a plurality of unexpected partner apparatuses in the network can be reduced. In other words, although the button operation is a simple operation, the network can be extended while the security thereof is being maintained.

Note that, the first embodiment of the present invention is described above using wireless LANs conforming to IEEE 802.11 series as examples. However, the present invention may be implemented in other wireless media such as media using wireless universal serial bus (USB), media using MBOA, media using Bluetooth (registered trademark), media using ultra wide band (UWB), or media using ZigBee. The present invention may be implemented in wired communication media such as wired LANs.

Here, MBOA stands for Multi Band OFDM alliance. Furthermore, UWB includes wireless USB, wireless 1394, WINET, and so forth.

Additionally, a network identifier, an encryption method, an encryption key, an authentication method, and an authentication key are used as examples of communication parameters. However, as a matter of course, other information may be used, or other information may be included in the communication parameters.

A recording medium on which a computer program code of software that realizes the above-described functions is recorded is provided in a system or apparatus, and a computer (a central process unit (CPU) or a micro processing unit (MPU)) of the system or apparatus reads and executes the computer program code stored on the recording medium, whereby the present invention can also be implemented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-284512, filed Nov. 5, 2008, which is hereby incorporated by reference herein in its entirety.

1. A communication apparatus comprising:
a first provision means for providing, so that the number of communication partners to which a communication parameter is to be provided is limited to M that is a plural number, the communication parameter to a communication partner in accordance with a predetermined operation performed by a user; and
a second provision means for providing, so that an upper limit number of communication partners is one, the communication parameter to a communication partner in accordance with the predetermined operation performed by the user,
wherein, when the predetermined operation is performed by the user again after a communication-parameter provision process performed by the first provision means has finished, the communication-parameter provision process is performed by the second provision means.

2. The communication apparatus according to claim 1, wherein the first provision means provides the communication parameter to a communication partner so that an upper limit number of communication partners is M which is a plural number during a period of time ending with a predetermined time limit.

3. The communication apparatus according to claim 1, wherein the second provision means provides the communication parameter in accordance with whether or not the first provision means has provided the communication parameter to M communication partners.

4. The communication apparatus according to claim 3, wherein, even when the predetermined operation is performed by the user after the first provision means has provided the communication parameter to the M communication partners, provision of the communication parameter is not performed by the second provision means.

5. A communication apparatus comprising:
a first provision means for providing a communication parameter to a plurality of communication partners during a period of time ending with a predetermined time limit in accordance with a predetermined operation performed by a user; and
a second provision means for providing, so that an upper limit number of communication partners is one, the communication parameter to a communication partner in accordance with the predetermined operation performed by the user,
wherein, when the predetermined operation is performed by the user again after a communication-parameter provision process performed by the first provision means has finished, the communication-parameter provision process is performed by the second provision means.

6. A method for controlling a communication apparatus, the method comprising controlling the communication apparatus to:
perform a process of providing, so that an upper limit number of communication partners is M which is a plural number, a communication parameter to a communication partner in accordance with a predetermined operation performed by a user; and
provide, when the predetermined operation is performed by the user again after the process has been performed, the communication parameter to a communication partner so that an upper limit number of communication partners is one.

7. The method for controlling the communication apparatus according to claim 6, wherein provision of the communication parameter so that an upper limit number of communication partners is M which is a plural number is performed during a period of time ending with a predetermined time limit.

8. A program for controlling a communication apparatus, the program being executed by a computer, the program comprising
controlling a communication apparatus to:
perform a process of providing, so that an upper limit number of communication partners is M which is a plural number, a communication parameter to a communication partner in accordance with a predetermined operation performed by a user; and
provide, when the predetermined operation is performed by the user again after the process has been performed, the communication parameter to a communication partner so that an upper limit number of communication partners is one.

9. The communication apparatus according to claim 2, wherein the second provision means provides the communication parameter in accordance with whether or not the first provision means has provided the communication parameter to M communication partners.

10. The communication apparatus according to claim 5, wherein the first provision means provides the communication parameter to a communication partner so that an upper limit number of communication partners is M which is a plural number during the period of time ending with a predetermined time limit.

11. The communication apparatus according to claim 5, wherein the second provision means provides the communication parameter in accordance with whether or not the first provision means has provided the communication parameter to M communication partners.

12. The communication apparatus according to claim 10, wherein the second provision means provides the communication parameter in accordance with whether or not the first provision means has provided the communication parameter to M communication partners.

13. The method for controlling the communication apparatus according to claim 6, further comprising providing the communication parameter in accordance with whether or not the communication parameter is provided to M communication partners.

14. The method for controlling the communication apparatus according to claim 7, further comprising providing the communication parameter in accordance with whether or not the communication parameter is provided to M communication partners.

15. The method for controlling the communication apparatus according to claim 7, wherein, even when the predetermined operation is performed by the user after the communication parameter is provided to the M communication partners, provision of the communication parameter is not performed.

16. The program for controlling the communication apparatus according to claim 8, wherein provision of the communication parameter so that an upper limit number of communication partners is M which is a plural number is performed during a period of time ending with a predetermined time limit.

17. The program for controlling the communication apparatus according to claim 8, further comprising providing the communication parameter in accordance with whether or not the communication parameter is provided to M communication partners.

18. The program for controlling the communication apparatus according to claim 17, wherein, even when the predetermined operation is performed by the user after the communication parameter is provided to the M communication partners, provision of the communication parameter is not performed.
